(19) United States
(12) Patent Application Publication
(10) Pub. No.: US 2012/0272808 A1
(43) Pub. Date: Nov. 1, 2012

(54) INTERCHANGEABLE GUITAR PICKGUARD

(75) Inventor: Sun Yang Kim, (US)

(73) Assignee: MSG 74 GROUP, INC, Corona, CA (US)

(21) Appl. No.: 13/097,506

(22) Filed: Apr. 29, 2011

(51) Int. Cl. G10D 3/00

(52) U.S. Cl. 84/291

(57) ABSTRACT

One example embodiment includes a guitar pickguard. The guitar pickguard includes a cover, where the cover is configured to cover at least a portion of a soundboard on a guitar. The guitar pickguard also includes attachment means, where the attachment means releasably attaches the cover to the soundboard.

### CROSS-REFERENCE TO RELATED APPLICATIONS

Not applicable.

### BACKGROUND OF THE INVENTION

The guitar and related instruments go back a long way in history. Although there have been variations, the basic stringed instrument with a body and a neck remains constant. The guitar is played with the neck raised slightly. The user selects the note to be played by pushing the guitar strings against the neck and strumming the strings. The pressure of the user's finger against the string and the neck changes the length of the string, modifying the note played by strumming the string.

Commonly, a guitar pick is used to strum the strings of a guitar. This helps to protect the musician's fingers and produce clean notes. However, picks have a major drawback in that they can damage the soundboard or other portions of the guitar. That is, the pick must be hard enough to ensure that it will not break when being used on the strings of the guitar. However, this means that it is also hard enough to scratch, gouge and otherwise damage the guitar.

Pickguards do exist which protect the soundboard from damage by a pick. However, these pickguards suffer from a number of drawbacks. In particular, the pickguards are permanently attached to the guitar. For example, the pickguards may be glued to the soundboard. While this secures the pickguard, it is difficult or impossible to remove the pickguard without damaging the soundboard.

Alternatively, the pickguard may be screwed to the soundboard of the guitar. While this does, theoretically, allow the pickguard to be changed, it is rather difficult in practice to do so. First, a screw driver must be used, which is not always available on a stage or other venue where the musician may wish the pickguard to be changed. Additionally, the number of screws may make changing the pickguard a time consuming task. If the musician wants to quickly change the pickguard, such as between songs or to remove it to give it to a fan, then having to locate a screwdriver and remove a number of screws may too time consuming to make it worth the effort.

In addition, the permanence of the pickguard means that the musician is unable to change the look of the guitar. In particular, the guitar will always appear the same. If the musician desires a different look, he/she must risk damaging the guitar in the process.

Finally, as the pickguard begins to wear, changing the pickguard may be necessary. However, if doing so has the potential to damage the guitar the musician may be understandably reluctant. This can leave the musician with the catch-22 of not changing the pickguard and allowing the guitar to potentially be damaged or to change the pickguard and allowing the guitar to potentially be damaged.

Accordingly, there is a need in the art for a pickguard which does not need to be glued to the soundboard. In addition, there is a need in the art for a pickguard which can be quickly and easily changed. Further, there is a need the art for pickguard which allows the musician to change to look of the guitar as desired.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a guitar pickguard. The guitar pickguard includes a cover, where the cover is configured to cover at least a portion of a soundboard on a guitar. The guitar pickguard also includes attachment means, where the attachment means releasably attaches the cover to the soundboard.

Another example embodiment includes a guitar pickguard. The guitar pickguard includes a cover, where the cover is configured to cover at least a portion of a soundboard on a guitar. The guitar pickguard also includes a faceplate, where the faceplate is configured to cover at least a portion of the cover. The guitar pickguard further includes attachment means, wherein the attachment means releasably attaches the cover and the faceplate to the soundboard.

Another example embodiment includes a guitar pickguard. The guitar pickguard includes a cover, where the cover is configured to cover at least a portion of a soundboard on a guitar and where the cover includes a set of holes. The guitar pickguard also includes a faceplate, where the faceplate is configured to cover at least a portion of the cover and where the faceplate includes a set of holes, where at least one of the holes in the set of holes is configured to match the position of at least one of the holes in the set of holes in the cover when the cover and the faceplate are positioned over the soundboard of the guitar. The guitar pickguard also includes one or more thumbscrews, where the one or more thumbscrews are configured to pass through the faceplate and the cover and releasably attach the faceplate and the cover to the soundboard of the guitar.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for protecting the soundboard of a guitar;

FIG. 2 illustrates an exploded view of the system;

FIG. 3 illustrates an example of a cover; and

FIG. 4 is a flowchart illustrating a method of attaching a guitar pickguard to the soundboard of a guitar.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

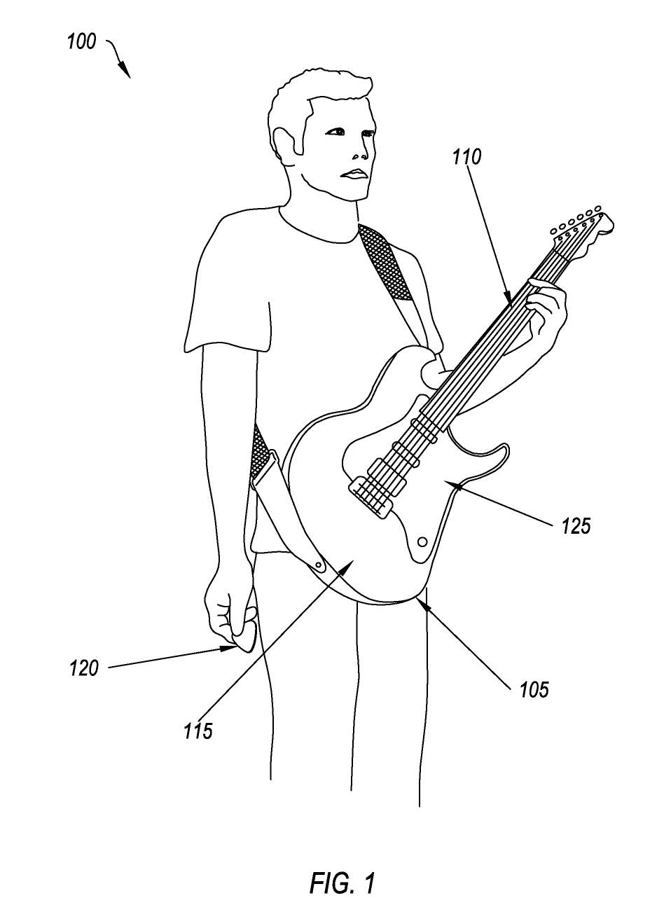

FIG. 1 illustrates an example of a system 100 for protecting the soundboard of a guitar. In at least one implementation, the system 100 can protect the soundboard from being scratched, gouged or otherwise damaged when the guitar is in use. In particular, the system 100 can protect against scratches caused by the user's fingers or other implements such as a guitar pick.

FIG. 1 shows that the system 100 includes a guitar 105. In at least one implementation, a guitar 105 includes a plucked string instrument. The guitar 105 includes of a body with a rigid neck to which the strings 110, generally six in number but sometimes more or less, are attached. The guitar 105 can be constructed of various materials and strung with animal gut or with either nylon or steel strings 110. The guitar 105 can include both acoustic and electric guitars.

In at least one implementation, acoustic guitars include hollow bodies. The tone of an acoustic guitar is produced by the vibration of the strings 110, which is amplified by the body of the guitar 105, which acts as a resonating chamber. Electric guitars rely on an amplifier that can electronically manipulate tone. Electric guitars can include a hollow body or a solid body.

FIG. 1 also shows that the guitar 105 can include a soundboard 115. In at least one implementation, the soundboard 115 is the top of a guitar 105. I.e., the soundboard 115 is the portion of the guitar 105 body immediately under the strings 110 of the guitar 105. The soundboard 115 plays a critical role in determining the overall tone and projection qualities of the guitar 105. The soundboard 115 can include any material desired by the musician. For example, the soundboard 115 can be constructed of plastic, wood or any other material.

One of skill in the art will appreciate that in the guitar 105 the sound is produced by the vibration of the strings 110. However, because the string 110 can only displace a small amount of air, the volume of the sound needs to be increased in order to be heard. In an acoustic guitar, this is accomplished by using a soundboard 115 and a resonant cavity, the sound box. I.e., the body of the guitar is hollow; the vibrating strings 110 drive the soundboard 115 through the bridge (a structure holding the strings 110 on the soundboard 115), making the soundboard 115 vibrate. The soundboard 115 has a larger surface area than the stings and thus the soundboard 115 displaces a larger volume of air than the stings, producing a much louder sound than the strings 110 alone. As the soundboard 115 vibrates, sound waves are produced from both the front and back faces.

In at least one implementation, in the back of the soundboard 115 is a pattern of struts and braces that provide stability to the soundboard 115, while allowing it to vibrate as uniformly as possible. The choice of material used for these struts and braces effects the sound less than the material of the soundboard 115. However, the bracing pattern can have a significant impact on the sound of the guitar 105. In addition to bracing patterns, hardwood plates designed to add support to the bridge and sound hole areas are also commonly attached to the underside of soundboards. Though the acoustic impact of these plates are minor compared to the bracing patterns, their size, shape and wood type can also affect the tone of the guitar 105.

FIG. 1 further shows that the system 100 can include a pick 120. In at least one implementation, a pick 120 is a plectrum, or a small flat tool, used to pluck the stings 110 on the guitar 105. The pick 120 can include plastic, rubber, felt, tortoiseshell, wood, metal, glass, stone or any other material. The pick 120 can be shaped in an acute isosceles triangle with the two equal corners rounded and the third corner rounded to a lesser extent. As the pick 120 is dragged across the strings 110 it may accidentally come in contact with the soundboard 115 of the guitar 105. This can create scratches or gouges in the soundboard 115.

FIG. 1 shows that the system 100 can include a pickguard 125. In at least one implementation, the pickguard 125 can include a piece of material that is placed over the soundboard 115. For example, the pickguard 125 can be placed under or near the strings 110. The pickguard 125 can protect the soundboard 115 from being scratched by the guitar pick 120.

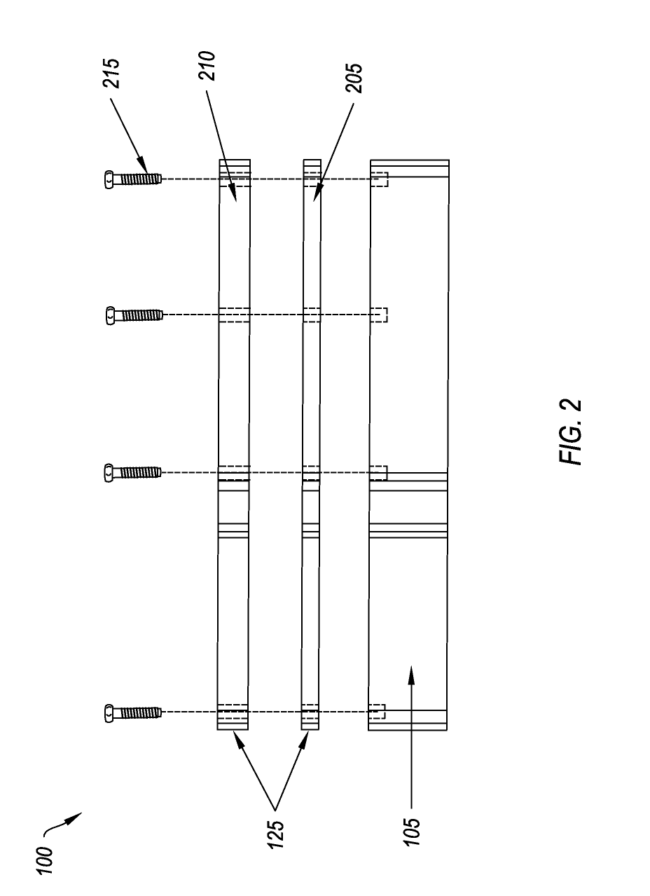

FIG. 2 illustrates an exploded view of the system 100. In at least one implementation, the system 100 includes a pickguard 125 mounted on a guitar 105. In at least one implementation, the pickguard 125 can protect the soundboard of the guitar 105 from being scratched by the pick when the guitar 105 is being played by the musician. In particular, the pick can include material that is harder than the soundboard. Consequently, any contact between the pick and the soundboard can result in scratches or other damage to the soundboard. The pickguard 125 can be used to protect the soundboard of the guitar 105.

FIG. 2 shows that the pickguard 125 can include a cover 205. In at least one implementation, the cover 205 can include an ornamental design for the pickguard 125. That is, the cover 205 can include ornamental aspects of the pickguard 125. The cover 205 can cover at least a portion of the soundboard. I.e., the cover 205 can be placed directly over the guitar 105.

FIG. 2 also shows that the pickguard 125 can include a faceplate 210. In at least one implementation, the faceplate 210 can cover at least a portion of the cover 205. In particular, the cover 205 can be placed between the faceplate 210 and the guitar 105. Therefore, attaching the faceplate 210 to the guitar 105 can hold the cover 205 in place, as described below.

In at least one implementation, the faceplate 210 can include any material that is of sufficient strength to protect the soundboard from being damaged by a pick. For example, the faceplate 210 can include plastic acrylic glass, glass, plywood, fabrics, metal and mother-of-pearl/pearloid varieties, exotic woods, furs, skins, gems, precious metals, or any other material. One of skill in the art will appreciate that, although shown as two pieces in FIG. 2, the cover 205 and the faceplate 210 can include a single piece. For example, the faceplate 210 can include ornamental designs and be attached directly to the guitar 105, without a separate cover 205.

FIG. 2 further shows that the pickguard 125 can include one or more connectors 215. In at least one implementation, the one or more connectors 215 can include any connector configured to attach the cover 205 and/or the faceplate 210 to the guitar 105. In particular, the one or more connectors 215 can be configured to the faceplate 210 to the guitar which holds the cover 205 in place. Additionally or alternatively, the one or more connectors 215 can be placed through one or more holes in the cover 205 and the faceplate 210, attaching both the cover 205 and the faceplate 210 to the guitar 105 simultaneously.

In at least one implementation, the one or more connectors can 215 include any mechanism capable of attaching the cover 205 and/or the faceplate 210 to the guitar 105. For example, the one or more connectors 215 can include glue or other adhesive. Additionally or alternatively, the one or more connectors 215 can be configured to ensure that the attachment is releasable. For example, the one or more connectors 215 can includes snaps, hook and loop fasteners, screws, clamps or any other releasable mechanism. As used in the specification and the claims, the term releasable shall mean that the one or more connectors 215 are easily removed. For example, the one or more connectors 215 can include thumb screws so that the one or more connectors 215 can be easily removed and the cover 205 and/or faceplate 210 can be removed.

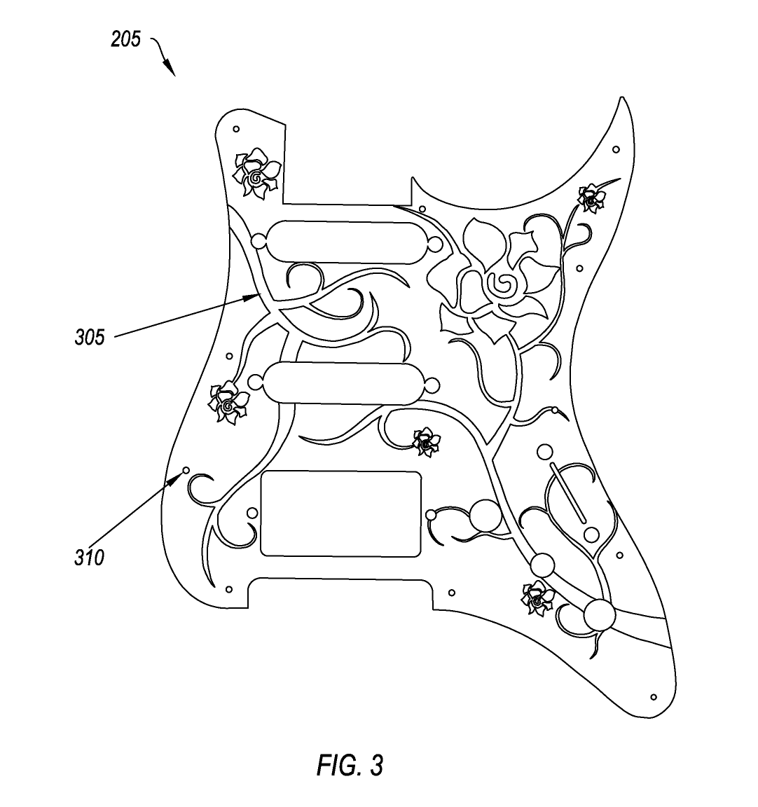

FIG. 3 illustrates an example of a cover 205. In at least one implementation, the cover 205 can be used to provide an ornamental aspect to a pickguard. In particular, the cover 205 can allow the musician to personalize his/her guitar with a preferred design. Because the cover 205 can be easily changed, as described above, the musician can change the cover 205 as desired.

FIG. 3 shows that the cover 205 can include an ornamental design 305. In at least one implementation, the ornamental design 305 can include a design, picture, pattern, artwork or any other appearance. Additionally or alternatively, the ornamental design 305 can include the shape of the cover 205. In particular, the shape can include any shape desired by the musician. For example, the musician can custom shape the cover 205 while retaining its functionality, as described above.

FIG. 3 further shows that the cover 205 can include one or more holes 310. In at least one implementation, the one or more holes 310 can allow the cover 205 to fit around parts of the guitar. For example, the one or more holes 310 can include a hole which is configured to surround or partially surround the sound hole of the guitar. Additionally or alternatively, the one or more holes 310 can include a hole to surround or partially surround the bridge, the string attachment or any other part of the guitar.

Additionally or alternatively, the one or more holes 310 can include hole for one or more connectors to pass through or otherwise allow the one or more connectors to connect the cover 205 to the guitar. For example, the one or more holes 310 can allow a thumbscrew to pass through the cover 205. As the thumbscrew is tightened, it can provide a force which attaches the cover 205 to the guitar. One of skill in the art will appreciate that if the pickguard is to include a faceplate or any other parts that the faceplate or other parts can include one or more holes configured to match the one or more holes 310 when placed over or under the cover 205.

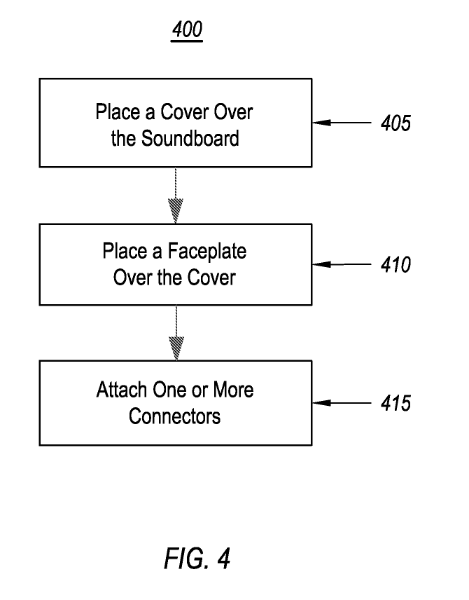

FIG. 4 is a flowchart illustrating a method 400 of attaching a guitar pickguard to the soundboard of a guitar. In at least one implementation, the pickguard can protect the soundboard of the guitar from being scratched or otherwise damaged by a pick while being played. One of skill in the art will appreciate that the method 400 can be used to attach the pickguard 125 of FIG. 1; however, the method 400 can be used to attach a pickguard other than the pickguard 125 of FIG. 1.

FIG. 4 shows that the method 400 can include placing a cover over the soundboard 405. In at least one implementation, the cover can include an ornamental design for the pickguard. That is, the cover can include ornamental aspects of the pickguard. The cover can cover at least a portion of the soundboard. I.e., the cover can be placed directly over the guitar. In at least one implementation, the cover can be used to provide an ornamental aspect to a pickguard. In particular, the cover can allow the musician to personalize his/her guitar with a preferred design. Because the cover can be easily changed the musician can change the cover as desired.

In at least one implementation, the cover can include an ornamental design. The ornamental design can include a design, picture, pattern, artwork or any other appearance. Additionally or alternatively, the ornamental design can include the shape of the cover. In particular, the shape can include any shape desired by the musician. For example, the musician can custom shape the cover while retaining its functionality, as described above.

In at least one implementation, the cover can include one or more holes. The one or more holes can allow the cover to fit around parts of the guitar. For example, the one or more holes can include a hole which is configured to surround or partially surround the sound hole of the guitar. Additionally or alternatively, the one or more holes can include a hole to surround or partially surround the bridge, the string attachment or any other part of the guitar.

Additionally or alternatively, the one or more holes can include hole for one or more connectors to pass through or otherwise allow the one or more connectors to connect the cover to the guitar. For example, the one or more holes can allow a thumbscrew to pass through the cover. As the thumbscrew is tightened, it can provide a force which attaches the cover to the guitar. One of skill in the art will appreciate that if the pickguard is to include a faceplate or any other parts that the faceplate or other parts can include one or more holes configured to match the one or more holes when placed over or under the cover.

FIG. 4 also shows that the method 400 can include placing a faceplate over the cover 410. In at least one implementation, the faceplate can cover at least a portion of the cover. In particular, the cover can be placed between the faceplate and the guitar. Therefore, attaching the faceplate to the guitar can hold the cover in place, as described below.

In at least one implementation, the faceplate can include any material that is of sufficient strength to protect the soundboard from being damaged by a pick. For example, the faceplate can include plastic acrylic glass, glass, plywood, fabrics, metal and mother-of-pearl/pearloid varieties, exotic woods, furs, skins, gems, precious metals, or any other material. One of skill in the art will appreciate that, although shown as two pieces in FIG. 2, the cover and the faceplate can include a single piece. For example, the faceplate can include ornamental designs and be attached directly to the guitar, without a separate cover.

FIG. 4 further shows that the method 400 can include attaching one or more connectors. In at least one implementation, the one or more connectors can include any connector configured to attach the cover and/or the faceplate to the guitar. In particular, the one or more connectors can be configured to the faceplate to the guitar which holds the cover in place. Additionally or alternatively, the one or more connectors can be placed through one or more holes in the cover and the faceplate, attaching both the cover 205 and the faceplate 210 to the guitar simultaneously.

In at least one implementation, the one or more connectors can include any mechanism capable of attaching the cover and/or the faceplate to the guitar. For example, the one or more connectors can include glue or other adhesive. Additionally or alternatively, the one or more connectors can be configured to ensure that the attachment is releasable. For example, the one or more connectors can includes snaps, hook and loop fasteners, screws, clamps or any other releasable mechanism. As used in the specification and the claims, the term releasable shall mean that the one or more connectors are easily removed. For example, the one or more connectors can include thumb screws so that the one or more connectors can be easily removed and the cover and/or faceplate can be removed.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A guitar pickguard, the guitar pickguard comprising:
a cover, wherein the cover is configured to cover at least a portion of a soundboard on a guitar;
attachment means, wherein the attachment means releasably attaches the cover to the soundboard.

2. The guitar pickguard of claim 1, wherein the cover includes plastic.

3. The guitar pickguard of claim 1, wherein the cover includes wood.

4. The guitar pickguard of claim 1, wherein the cover includes fabric.

5. The guitar pickguard of claim 1, wherein the attachment means includes a screw.

6. The guitar pickguard of claim 5, wherein the screw includes a thumb screw.

7. The guitar pickguard of claim 1, wherein the attachment means includes a hook and loop fastener.

8. The guitar pickguard of claim 1, wherein the attachment means includes a snap.

9. The guitar pickguard of claim 1 further comprising a faceplate, wherein the faceplate is configured to cover at least a portion of the cover.

10. A guitar including the guitar pickguard of claim 1.

11. A guitar pickguard, the guitar pickguard comprising:
a cover, wherein the cover is configured to cover at least a portion of a soundboard on a guitar;
a faceplate, wherein the faceplate is configured to cover at least a portion of the cover; and
attachment means, wherein the attachment means releasably attaches the cover and the faceplate to the soundboard.

12. The guitar pickguard of claim 11, wherein the attachment means attaches the faceplate to the soundboard, wherein the pressure of the faceplate against the soundboard holds the cover in place.

13. The guitar pickguard of claim 11, wherein the cover is configured to cover the entire soundboard.

14. The guitar pickguard of claim 13, wherein the face plate is configured to cover the entire cover.

15. The guitar pickguard of claim 13, wherein the cover includes an ornamental design.

16. A guitar including the guitar pickguard of claim 11.

17. A guitar pickguard, the guitar pickguard comprising:
a cover, wherein the cover:
is configured to cover at least a portion of a soundboard on a guitar; and
includes a set of holes;
a faceplate, wherein the faceplate:
is configured to cover at least a portion of the cover; and
includes a set of holes, wherein at least one of the holes in the set of holes is configured to match the position of at least one of the holes in the set of holes in the cover when the cover and the faceplate are positioned over the soundboard of the guitar; and
one or more thumbscrews, wherein the one or more thumbscrews are configured to pass through the faceplate and the cover and releasably attach the faceplate and the cover to the soundboard of the guitar.

18. The guitar pickguard of claim 17, wherein the faceplate is clear.

19. The guitar pickguard of claim 17, wherein the faceplate is made of plastic.

20. The guitar pickguard of claim 17, wherein the faceplate includes an ornamental design.
